(19) United States
(12) Patent Application Publication
(10) Pub. No.: US 2022/0404608 A1
(43) Pub. Date: Dec. 22, 2022

(54) APPARATUS, SYSTEM, AND METHOD FOR SELECTIVELY COMPENSATING FOR CORRECTIVE LENSES APPLIED TO DISPLAY DEVICES DURING TESTING

(71) Applicant: META PLATFORMS TECHNOLOGIES, LLC, Menlo Park, CA (US)

(72) Inventors: Robin Sharma, Woodinville, WA (US); Yun-Han Lee, Redmond, WA (US); Difei Qi, Bellevue, WA (US); Konstantin Kudinov, Seattle, WA (US)

(21) Appl. No.: 17/721,760

(22) Filed: Apr. 15, 2022

Related U.S. Application Data
(60) Provisional application No. 63/212,260, filed on Jun. 18, 2021.

(51) Int. Cl. G02B 26/06; H04N 5/232; H04N 5/225; H04N 17/00; G02B 27/00

(52) U.S. Cl. CPC G02B 26/06; H04N 5/23229; H04N 5/2254; H04N 17/004; G02B 27/0025

(57) ABSTRACT

An apparatus comprising (1) a conoscope configured to receive an image emitted by a display device through a corrective lens, (2) a variable compensation element coupled to the conoscope, wherein the variable compensation element is capable of selectively modifying the image emitted by the display device to compensate for an optical effect imparted by the corrective lens on the image, and (3) a controller coupled to the variable compensation element, wherein the controller (1) receives a compensation parameter representative of the optical effect imparted by the corrective lens on the image, (2) selects, based at least in part on the compensation parameter, a feature of the variable compensation element that compensates for the optical effect, and (3) causing the feature of the variable compensation element to be applied to the image. Various other apparatuses, systems, and methods are also disclosed.

### INCORPORATION BY REFERENCE

This application claims the benefit of priority under 35 U.S.C. § 119(e) to U.S. Provisional Application No. 63/212,260 filed Jun. 18, 2021, the contents of which are incorporated herein by reference in their entirety.

### BRIEF DESCRIPTION OF DRAWINGS

The accompanying drawings illustrate a number of exemplary embodiments and are parts of the specification. Together with the following description, the drawings demonstrate and explain various principles of the instant disclosure.

FIG. 1 is an illustration of an exemplary apparatus for selectively compensating for corrective lenses applied to display devices during testing according to one or more embodiments of this disclosure.

FIG. 2 is an illustration of an exemplary conoscope incorporated in an apparatus that facilitates selectively compensating for corrective lenses applied to display devices during testing according to one or more embodiments of this disclosure.

FIG. 3 is an illustration of an exemplary apparatus for selectively compensating for corrective lenses applied to display devices during testing according to one or more embodiments of this disclosure.

FIG. 4 is an illustration of an exemplary system for selectively compensating for corrective lenses applied to display devices during testing according to one or more embodiments of this disclosure.

FIG. 5 is an illustration of an exemplary variable compensation element that includes various selectable features capable of being applied to the conoscope according to one or more embodiments of this disclosure.

FIG. 6 is a flowchart of an exemplary method for selectively compensating for corrective lenses applied to display devices during testing according to one or more embodiments of this disclosure.

FIG. 7 is an illustration of exemplary augmented-reality glasses that may be used in connection with embodiments of this disclosure.

FIG. 8 is an illustration of an exemplary virtual-reality headset that may be used in connection with embodiments of this disclosure.

While the exemplary embodiments described herein are susceptible to various modifications and alternative forms, specific embodiments have been shown by way of example in the drawings and will be described in detail herein. However, the exemplary embodiments described herein are not intended to be limited to the particular forms disclosed. Rather, the instant disclosure covers all modifications, combinations, equivalents, and alternatives falling within this disclosure.

### DETAILED DESCRIPTION

The present disclosure is generally directed to apparatuses, systems, and methods for selectively compensating for corrective lenses applied to display devices during testing. As will be explained in greater detail below, these apparatuses, systems, and methods may provide numerous features and benefits.

In certain examples, a display of an augmented reality and/or virtual reality (AR/VR) device may emit collimated light toward a user's eyes. In some AR/VR devices, prescription lenses may be placed between the user's eyes and the AR/VR display to correct for imperfections and/or refractive errors of the user's eyes. Unfortunately, these prescription lenses are typically not easily removable. Moreover, these prescription lenses may present difficulties related to the characterization of the AR/VR display's performance through metrics like modulation transfer function (MTF) and/or display color uniformity. The MTF of an AR/VR display may represent resolution properties and/or quantify the sharpness of the display at different spatial frequencies.

In some situations, it would be very useful to characterize display parameters (such as MTF and/or color uniformity) for an AR/VR device that includes a prescription lens. However, a well-focused image may be needed for accurate evaluation, and the presence of a prescription lens may distort the image emitted by the AR/VR device, thus making a well-focused image difficult to obtain. For example, a prescription lens is often customized for a particular user and/or a particular group of users. As a result, this prescription lens may introduce variable modifications to the wavefront of light from an AR/VR display that makes an MTF determination and/or color uniformity measurement difficult.

Visual perception may account for more than 80% of all information humans receive and/or consume from the real world. For this reason, a top priority for all modalities of creating a realistic and/or believable AR/VR experience may involve generating artificial images for human eyes. Efforts directed to this end may necessitate development and/or productization of so-called near-eye displays (NEDs). Development and/or production of such NEDs may be a complex scientific and/or engineering endeavor that includes not only the development and/or production of the displays themselves but also the creation of all the necessary infrastructure for characterization, testing, and/or metrology of such displays in a scalable way.

In some situations, the characterization of AR/VR displays may be useful for a variety of quality and/or calibration purposes. Examples of applications for characterization and/or measurement devices include, without limitation, the evaluation of display prototypes, quality control on display production lines, compliance checks (e.g., related to safety regulations) in connection with displays, and/or calibration and adjustment of displays before or during use, combinations or variations of one or more of the same, and/or any other suitable applications.

Contemporary AR/VR displays may push the boundaries of optical system design with the aim of increasing the user's field of view and/or eye box, increasing display efficiency, and/or decreasing display size and/or weight. In this race for better performance and/or efficiency, some metrics (e.g., MTF and/or angular uniformity) may be sacrificed in an effort to optimize other parameters. Such a trade-off may be justified as the display uniformity and/or other deficiencies are often detected and/or corrected through proper calibration during testing. While it may alleviate certain pressures on display developers, this approach may create additional challenges for optical metrology since a significant amount of data needs to be collected, processed, and/or stored to facilitate such testing and/or calibration. This approach may also lead to a very lengthy factory process that requires expensive automated machinery with customized features and/or devices.

Examples of test and calibration approaches that AR/VR displays undergo include display MTF and/or color uniformity calibration. One purpose of the display MTF test is to ensure the virtual image created by the display meets required MTF specifications when viewed from several distinct angles. In some examples, this MTF test may engage and/or deploy a complex system with several cameras. In such examples, each camera may observe the virtual image at a defined angle and/or perform necessary data collection. The use of several cameras in this way may allow and/or facilitate the capture of information about all angles simultaneously. However, this approach may have a number of significant drawbacks, including high cost (e.g., the apparatus may necessitate up to 30 expensive cameras), complicated alignment and/or audit procedures, large system size and/or footprint, substantial weight, and/or considerable inconvenience.

In some situations, MTF measurements may be complicated further if the AR/VR devices under test are adjusted for users with different visual acuity. For example, an AR/VR device may include and/or incorporate prescription lenses for one or both eyes, and these prescription lenses may be nonremovably fixed and/or attached to the AR/VR display. Accordingly, removal of the prescription lenses may not be feasible outside of professional servicing. These prescription lenses may modify the image projected by the AR/VR display similar to how prescription glasses compensate for near or farsightedness.

The requirements for determining the MTF and/or measuring color uniformity of an AR/VR display with prescription lenses may present further challenges. Refractive error corrections for distance vision of any given eye may include three primary variables, namely sphere (Sph), cylinder (Cyl), and/or axis of cylinder (Ax). As a result of varying values for these variables, there may be a large number of unique lens prescriptions (e.g., 500,000 different options). For optical power variations alone, there may be a large number (e.g., hundreds or more) of prescription lens powers needed during display characterization (e.g., for determination of a display parameter such as MTF).

In some situations, it may appear particularly challenging to determine the MTF and/or color uniformity of an AR/VR display whose prescription lenses provide astigmatism correction. Such prescription lenses may add further variable modifications to the wavefront of light emitted from the AR/VR display. One approach to addressing this challenge may involve focusing the image sequentially along different astigmatic axes. Unfortunately, this approach may lead to extensive focus control, additional device under test and/or apparatus adjustment, complicated data processing, and/or large measurement errors.

In some situations, it may be very useful to determine display MTF and/or color uniformity using a single camera and a single image capture. Moreover, a prescription lens may introduce monocular aberrations on the emergent light wavefront that dominates any MTF or color uniformity measurement in the absence of a compensation element. Hence, compensation for these monocular aberrations may be needed for accurate MTF and/or color uniformity determinations. The instant disclosure, therefore, identifies and addresses a need for additional and improved apparatuses, systems, and methods for selectively compensating for prescription lenses applied to display devices during testing.

As will be described in greater detail below, an apparatus and/or system may be configured to compensate for many possible prescription lenses in order to convey a sharp image from an AR/VR display under test onto an image sensor. By doing so, the apparatus and/or system may facilitate and/or support accurate determinations of the MTF and/or color uniformity of that AR/VR display. In some examples, the apparatus and/or system may be configured to obtain the MTF and/or color uniformity of that AR/VR display. In such examples, the MTF and/or color uniformity determinations may indicate and/or represent the image sharpness on the AR/VR display. These MTF and/or color uniformity determinations may be used to ensure that the AR/VR display meets and/or satisfied certain quality standards prior to release and/or shipment.

In some examples, such an apparatus and/or system may include a light collection element (e.g., an optical element such as a lens of a conoscope) configured to collect light from a display over a range of viewing angles. By collecting light from a range of viewing angles, this apparatus and/or system may mitigate and/or eliminate the conventional requirement of multiple cameras arranged at multiple locations for testing and/or calibration. Accordingly, this apparatus and/or system may necessitate and/or include only a single camera, thereby facilitating reduced costs as well as greatly simplified alignment and/or operation during testing and/or calibration.

In some examples, such an apparatus and/or system may implement and/or include a compensation element (such as a feature of a phase plate array) that facilitates compensating for a prescription lens incorporated in the AR/VR device under test. In one example, the compensation element may be positioned, placed, and/or located within or proximate to a pupil conjugated area of a conoscope included in the apparatus and/or system. In this example, the compensation element may be selected from a plurality of such elements (incorporated, e.g., in a phase plate array) based at least in part on the properties and/or characteristics of the prescription lens applied to the AR/VR device. This compensation element may compensate and/or account for the effect of the prescription lens on the image quality. Accordingly, this compensation element may enable the optical configuration of the apparatus and/or system achieve and/or succeed with a very simple design (e.g., including certain fixed optical features).

In some examples, adjustment for a prescription lens incorporated in the AR/VR device may involve the automatic selection and/or application of a compensation element from an array of such elements arranged on a phase plate array. In such examples, light from the AR/VR display may be modified by the prescription lens, and the compensation element may reverse the effect of the prescription lens. In one example, such an apparatus and/or system may include and/or represent an afocal optical relay device that is bi-telecentric, a potentially telecentric eye-piece lens, an image sensor, and/or a compensation plate (e.g., a phase plate array).

In some examples, such an apparatus and/or system may facilitate and/or support determinations and/or calibrations of MTF and/or color uniformity or sharpness for AR/VR displays fitted and/or equipped with prescription lenses. These prescription lenses may provide and/or impart only spherical corrections, only cylindrical corrections, or both spherical and cylindrical corrections. In one example, such an apparatus and/or system may include and/or represent a conoscope and/or another optical device configured to collect light from an AR/VR display at several viewing angles, thereby facilitating and/or supporting MTF and/or color uniformity determinations using a single camera. Additionally or alternatively, such an apparatus and/or system may include and/or represent a special prism and/or reflector (e.g., an airspace reflector) configured to collect light from the AR/VR display at several viewing angles.

In some examples, the compensation element of such an apparatus and/or system may include and/or represent at least one Pancharatnam-Berry phase (PBP) optical element. In one example, the selection, adjustment, insertion, and/or application of such a compensation element may be automated and directed by a controller (e.g., a processing device). Additionally or alternatively, such a compensation element may be chosen based at least in part on one or more adjustment parameters and/or optical properties of the prescription lens applied to the AR/VR display under test.

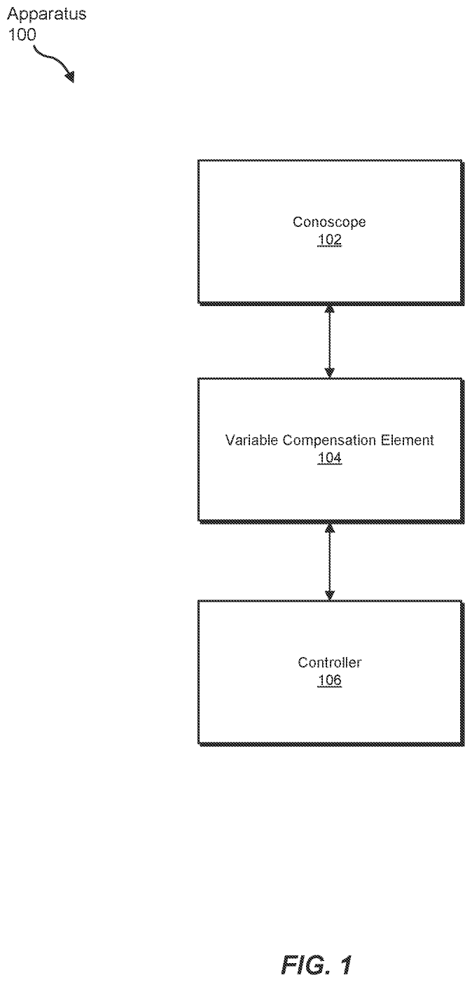

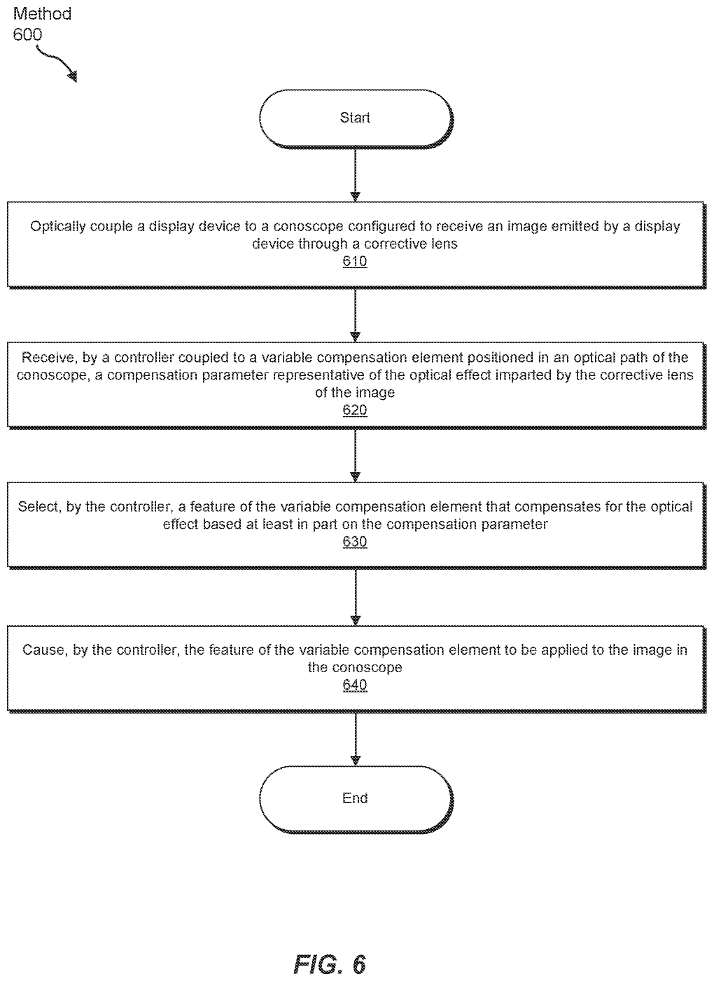

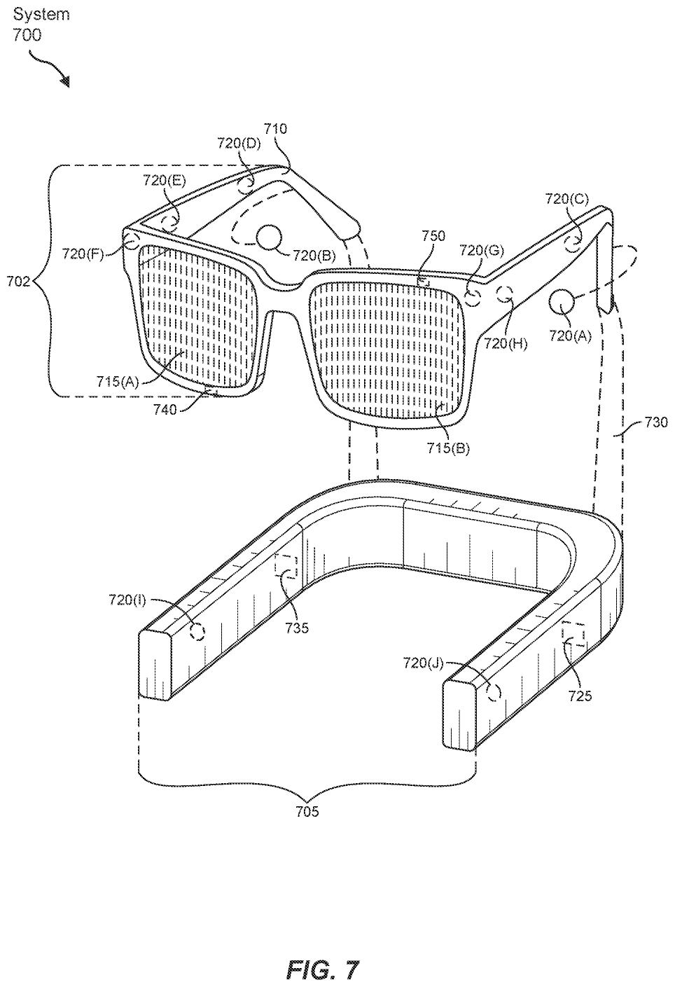

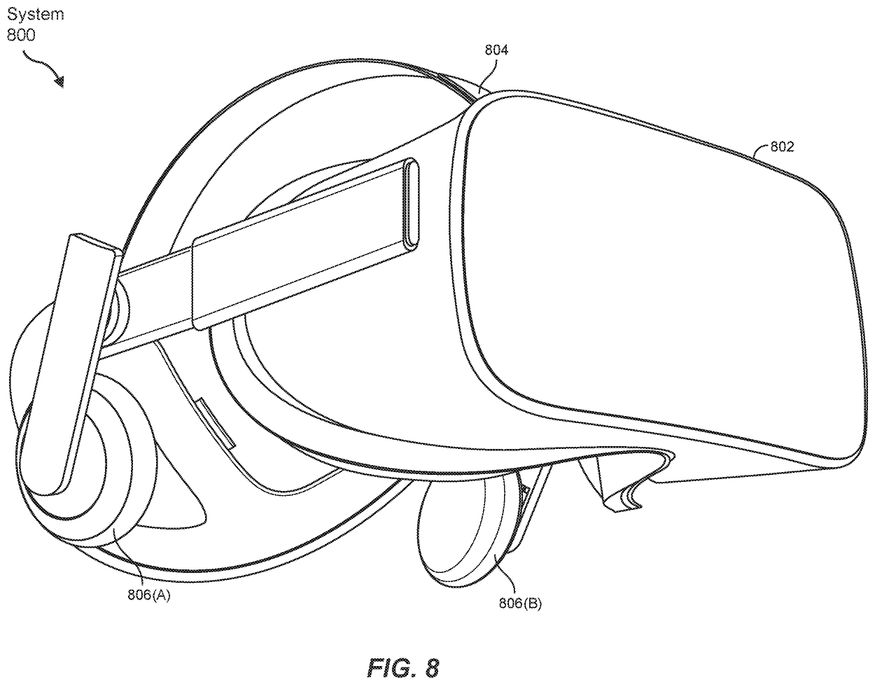

The following will provide, with reference to FIGS. 1-5, detailed descriptions of exemplary devices, systems, components, and corresponding implementations for selectively compensating for corrective lenses applied to display devices during testing. In addition, detailed descriptions of methods for selectively compensating for corrective lenses applied to display devices during testing in connection with FIG. 6. The discussion corresponding to FIGS. 7 and 8 will provide detailed descriptions of types of exemplary artificial-reality devices, wearables, and/or associated systems that may be tested and/or calibrated using one of the apparatuses, systems, and/or methods disclosed herein.

FIG. 1 illustrates an exemplary apparatus 100 that facilitates and/or supports selectively compensating for corrective lenses applied to display devices during testing. As illustrated in FIG. 1, exemplary apparatus 100 may include and/or represent a conoscope 102, a variable compensation element 104, and/or a controller 106. In some examples, conoscope 102 may be configured to receive, detect, and/or accept an image emitted by a display device through a corrective lens. In such examples, variable compensation element 104 may be physically, directly, indirectly, and/or optically coupled to conoscope 102. In one example, variable compensation element 104 may be capable of selectively modifying the image emitted by the display device to compensate for an optical effect imparted by the corrective lens on the image.

In some examples, controller 106 may be physically, directly, indirectly, and/or communicatively coupled to variable compensation element 104. In one example, controller 106 may receive and/or obtain a compensation parameter representative of the optical effect imparted by the corrective lens on the image. Controller 106 may receive and/or obtain this compensation parameter in a variety of different ways. For example, controller 106 may receive and/or obtain the compensation parameter as user input from a technician conducting a test of the display device via a user interface. In another example, the display device may be programmed with information that identifies certain attributes of the corrective lens, and controller 106 may be communicatively coupled (via, e.g., a wireless and/or wired connection) to the display device. In this example, controller 106 may receive and/or obtain the information that identifies those attributes of the corrective lens from the display device via the communicative coupling.

In some examples, the compensation parameter may constitute and/or represent one or more features and/or attributes of the corrective lens through which the image is emitted. Additionally or alternatively, the compensation parameter may constitute and/or represent one or more features and/or attributes of the optical effect imparted by the corrective lens on the image. Examples of the compensation parameter include, without limitation, spherical powers of corrective lenses, cylindrical powers of corrective lens, cylindrical axes of corrective lenses, combination or variations of one or more of the same, and/or any other suitable compensation parameters.

In some examples, controller 106 may select a feature of variable compensation element 104 that compensates and/or accounts for the optical effect imparted by the corrective lens based at least in part on the compensation parameter. In one example, variable compensation element 104 may include and/or represent a phase plate array with a plurality of selectable features. In this example, controller 106 may identify one of the selectable features of the phase plate array as being capable of counteracting and/or reversing the optical effect imparted by the corrective lens on the image. For example, when applied to the image, the selected feature of the phase plate array may counteract and/or reverse the optical effect imparted on the image by a spherical power, cylindrical power, and/or cylindrical axis of the corrective lens. This counteraction and/or reversal of the optical effect may correct and/or condition the image for proper testing and/or calibration of the display device by apparatus 100 and/or a corresponding image sensor.

In some examples, controller 106 may cause the feature of variable compensation element 104 to be applied to the image. In one example, upon selection of the feature of variable compensation element 104, controller 106 may maneuver and/or adjust variable compensation element 104 such that the selected feature is applied to the image before the image reaches the image sensor. Controller 106 may maneuver and/or adjust variable compensation element 104 in a variety of different ways. For example, apparatus 100 may include and/or represent a phase-plate positioning mechanism (not necessarily illustrated in FIG. 1) that is communicatively coupled to controller 106 and/or configured to move variable compensation element 104 in one or more directions (e.g., rotationally, laterally, horizontally, vertically, diagonally, etc.). In this example, controller 106 may direct and/or instruct the phase-plate positioning mechanism to move variable compensation element 104 to a position and/or placement that causes the selected feature to be applied to the image as the image passes through conoscope 102.

In some examples, conoscope 102 may include and/or represent any type or form of device and/or component that performs, facilitates, and/or supports conoscopic measurements and/or observations. In one example, conoscope 102 may include and/or represent one or more optical components. Examples of such optical components include, without limitation, lenses, quarter wave plates, reflectors, polarizers, retarders, partial reflectors, reflective polarizers, optical films, compensators, beam splitters, alignment layers, color filters, protection sheets, glass components, plastic components, apertures, Fresnel lenses, convex lenses, concave lenses, filters, spherical lenses, cylindrical lenses, compensators, coatings, combinations or variations of one or more of the same, and/or any other suitable optical components. In one example, conoscope 102 may include and/or represent a telecentric lens stack capable of performing one or more optical functions, including image scaling, lens correction, polarization, reflection, retardation, refraction, light collection, optical aberration correction, gamma correction and/or adjustment, multi-image blending and/or overlaying, display overdrive compensation, Mura correction, dithering, image decompression, noise correction, image distortion, contrasting, and/or sharpening, among other functions.

In some examples, the optical components of conoscope 102 may include and/or contain a variety of different materials. Examples of such materials include, without limitation, plastics, glasses (e.g., crown glass), polycarbonates, combinations or variations of one or more of the same, and/or any other suitable materials. The optical components may be defined and/or formed in a variety of shapes and/or sizes.

In some examples, variable compensation element 104 may include and/or represent any type or form of phase plate array and/or phase compensation plate. In such examples, the phase plate array and/or the phase compensation plate may include and/or represent a plurality of selectable features (such as phase compensation elements). In one example, the selectable features may include and/or represent a set of PBP optical elements and/or correctors. Additionally or alternatively, at least a portion of variable compensation element 104 may be sized and/or dimensioned to fit within an optical tray positioned in an optical path of the image within conoscope 102.

In some examples, variable compensation element 104 may include and/or represent one or more spherical-power features and/or adapters capable of counteracting and/or reversing the spherical powers or effects of the corrective lens applied to the display device under test. In other examples, variable compensation element 104 may include and/or represent one or more cylindrical-power features and/or adapters capable of counteracting and/or reversing the cylindrical powers or effects of the corrective lens applied to the display device under test. Additionally or alternatively, variable compensation element 104 may include and/or represent one or more cylindrical-axis features and/or adapters capable of counteracting and/or reversing the cylindrical axis of the corrective lens applied to the display device under test. Finally, variable compensation element 104 may include and/or represent one or more field-curvature features and/or adapters capable of counteracting and/or reversing the field curvature and/or magnification effects of the corrective lens applied to the display device under test.

In some examples, controller 106 may include and/or represent any type or form of hardware-implemented processing device and/or system capable of interpreting and/or executing computer-readable instructions. In one example, controller 106 may access and/or modify certain software modules stored in memory to facilitate and/or support selectively compensating for corrective lenses applied to display devices during testing. Examples of controller 106 include, without limitation, physical processors, Central Processing Units (CPUs), microprocessors, microcontrollers, Field-Programmable Gate Arrays (FPGAs) that implement softcore processors, Application-Specific Integrated Circuits (ASICs), portions of one or more of the same, variations or combinations of one or more of the same, and/or any other suitable controller.

In some examples, apparatus 100 may include and/or represent one or more additional components, devices, and/or mechanisms that are not necessarily illustrated and/or labelled in FIGS. 1-5. For example, conoscope 102 may include and/or represent one or more lenses that are not necessarily illustrated and/or labelled in FIGS. 1-5. In another example, although not necessarily illustrated and/or labelled in this way in FIGS. 1-5, apparatus 100 may include and/or represent additional optical components, circuitry, processors, memory devices, cabling, connectors, springs, motors, and/or actuators, among other components. In further examples, apparatus 100 may exclude and/or omit one or more of the components, devices, and/or mechanisms that are illustrated and/or labelled in FIGS. 1-5.

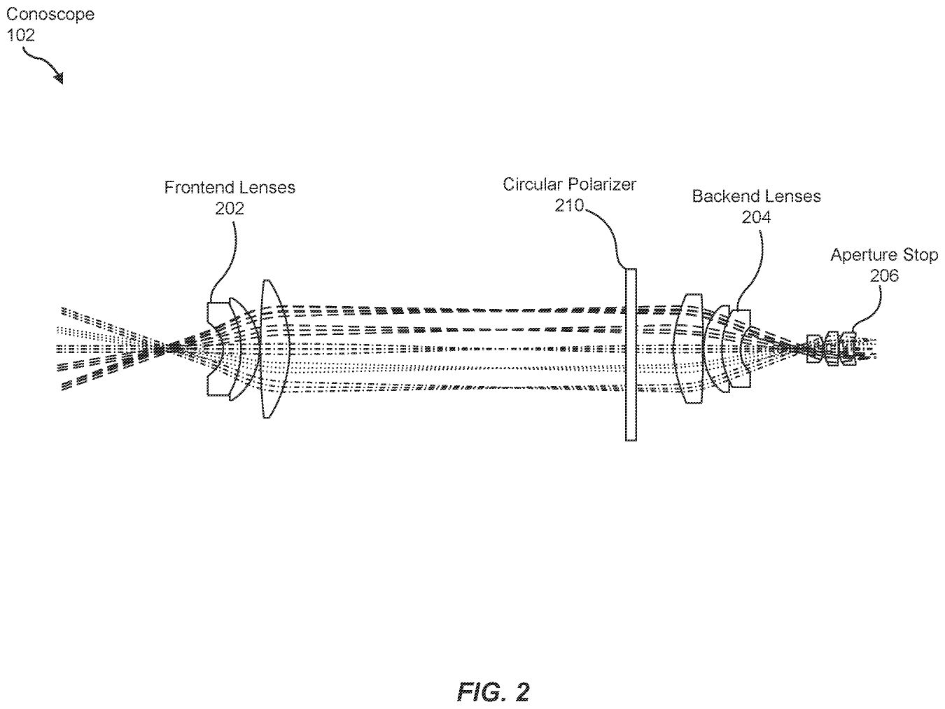

FIG. 2 illustrates an exemplary implementation of conoscope 102 that facilitates and/or supports selectively compensating for corrective lenses applied to display devices during testing. As illustrated in FIG. 2, exemplary conoscope 102 may include and/or represent frontend lenses 202, backend lenses 204, an aperture stop 206, and/or a circular polarizer 210. In one example, frontend lenses 202 may include and/or represent a light-collection and/or imaging lens configured to collect collimated light representative of the image emitted by a display device. In this example, frontend lenses 202 may collect the collimated light as emitted by the display device over a range of viewing angles. Additionally or alternatively, backend lenses 204 may include and/or represent an image-forming lens configured to form the image from the collimated light for presentation on an image sensor.

In some embodiments, frontend lenses 202 and backend lenses 204 may be similar and/or identical to one another. In such embodiments, frontend lenses 202 and backend lenses 204 may be positioned and/or configured with opposing orientations relative to one another within conoscope 102.

In some examples, frontend lenses 202 may be positioned and/or placed nearest and/or proximate to the display device under test. In such examples, aperture stop 206 may be positioned and/or placed nearest and/or proximate to the image sensor. In one example, circular polarizer 210 and/or backend lenses 204 may be positioned and/or placed proximate to one another between frontend lenses 202 and aperture stop 206. More specifically, circular polarizer 210 may be positioned and/or placed between frontend lenses 202 and backend lenses 204. Additionally or alternatively, backend lenses 204 may be positioned and/or placed between circular polarizer 210 and aperture stop 206. Accordingly, light emitted by the display device may enter conoscope 102 at and/or through frontend lenses 202 and then traverse toward circular polarizer 210. After passing through circular polarizer 210, the light may traverse toward backend lenses 204 before exiting conoscope 102 via aperture stop 206.

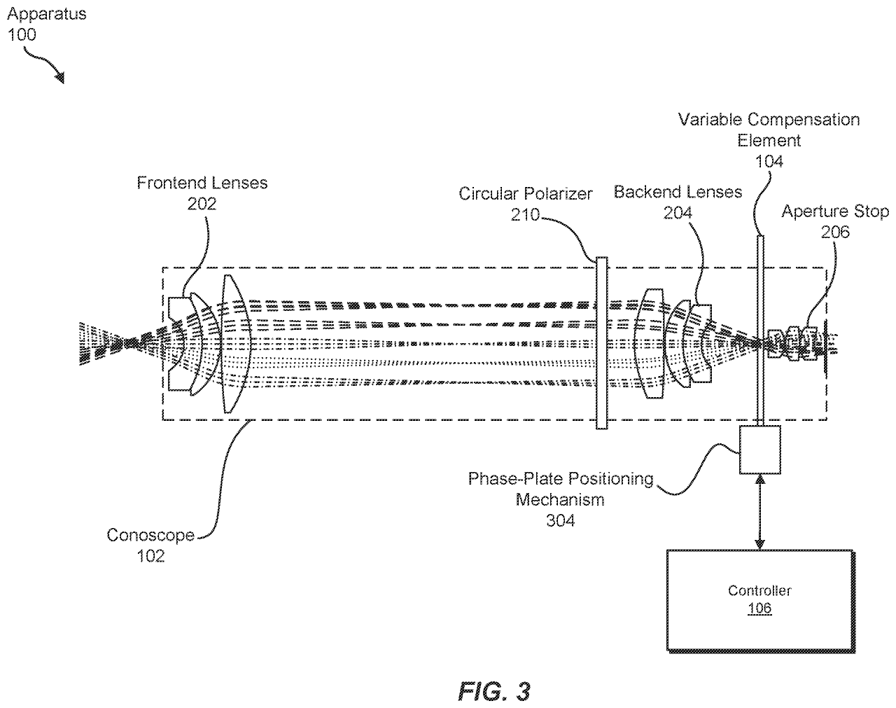

FIG. 3 illustrates an exemplary implementation of apparatus 100 that facilitates and/or supports selectively compensating for corrective lenses applied to display devices during testing. As illustrated in FIG. 3, this exemplary implementation of apparatus 100 may include and/or represent conoscope 102, variable compensation element 104, and/or controller 106. In some examples, apparatus 100 may include and/or represent a phase-plate positioning mechanism 304 communicatively coupled to controller 106. Additionally or alternatively, phase-plate positioning mechanism 304 may be physically and/or communicatively coupled to variable compensation element 104. In such examples, phase-plate positioning mechanism 304 may be configured to move variable compensation element 104 in one or more directions (e.g., rotationally, laterally, horizontally, vertically, diagonally, etc.) relative to conoscope 102. In one example, phase-plate positioning mechanism 304 may move variable compensation element 104 into a position that causes a feature selected by controller 106 to be applied to the image as the image passes through conoscope 102.

In some examples, phase-plate positioning mechanism 304 may include and/or represent one or more devices and/or components that apply force to variable compensation element 104. The force applied by such devices and/or components may cause and/or direct variable compensation element 104 to move into a certain position relative to the optical path of conoscope 102. Examples of such devices and/or components include, without limitation, actuators, rotators, servomotors, Direct Current (DC) motors, Alternating Current (AC) motors, variations or combinations of one or more of the same, and/or any other suitable devices and/or components.

In some examples, by moving variable compensation element 104 into that position, phase-plate positioning mechanism 304 may align the selected feature of variable compensation element 104 with the optical path of conoscope 102. For example, phase-plate positioning mechanism 304 may engage one or more actuators to move variable compensation element 104 relative to and/or within an optical tray of conoscope 102 such that the selected feature is applied to the image as the image traverses the optical path of conoscope 102.

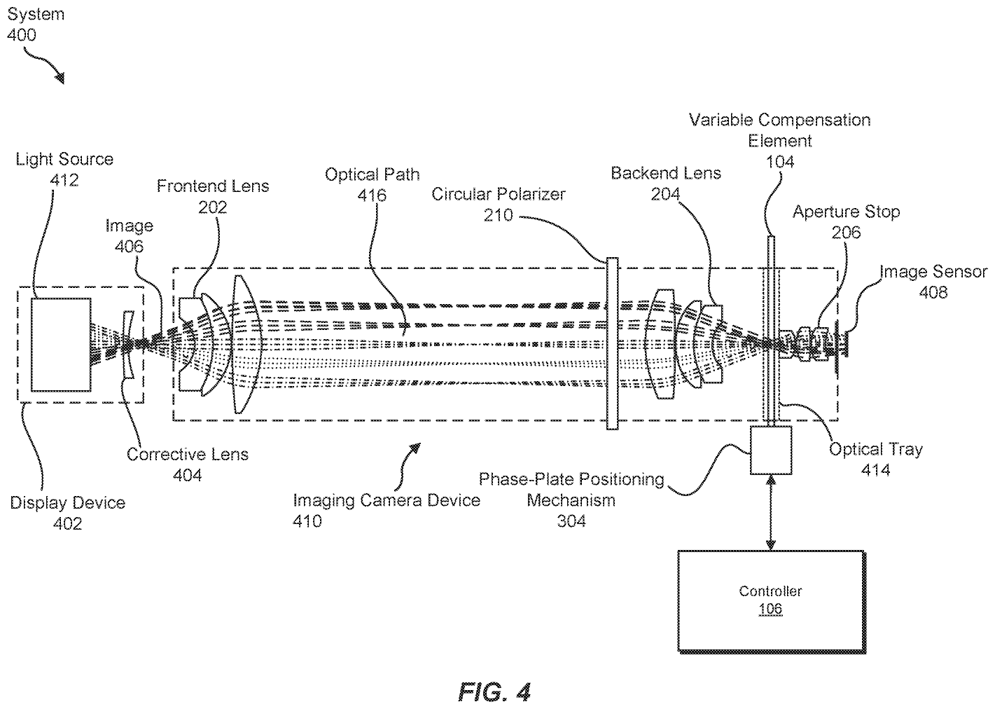

FIG. 4 illustrates an exemplary system 400 that facilitates and/or supports selectively compensating for a corrective lens 404 applied to a display device 402 during testing. As illustrated in FIG. 4, exemplary system 400 may include and/or represent display device 402 and/or an imaging camera device 410. In some examples, imaging camera device 410 may be optically coupled to display device 402. In one example, imaging camera device 410 may include and/or represent conoscope 102, variable compensation element 104, and/or controller 106. In this example, imaging camera device 410 may include and/or represent an image sensor 408 that is physically, directly, indirectly, and/or optically coupled to variable compensation element 104.

In some examples, display device 402 may include and/or represent a light source 412 that emits, projects, and/or transmits an image 406 as collimated light through a corrective lens 404. In such examples, corrective lens 404 may compensate and/or account for imperfections and/or deficiencies in the vision of those users (much like prescription glasses). As a result of corrective lens 404, image 406 may be subjected to one or more optical effects that alter and/or distort the collimated light in one way or another relative to its original form.

In some examples, corrective lens 404 may modify, alter, and/or change image 406 to compensate for refractive errors experienced by those users. Examples of such refractive errors include, without limitation, myopia, hypermetropia, astigmatism, presbyopia, combinations or variations of one or more of the same, and/or any other vision imperfections and/or deficiencies. To accurately test and/or calibrate the quality of image 406 after passing through corrective lens 404, image 406 may undergo further modification by various adapters included in imaging camera device 410 before reaching image sensor 408. In certain embodiments, corrective lens 404 may include and/or represent any type or form of prescription lens and/or transmissible optical device prescribed by a physician and/or doctor (such as an ophthalmologist and/or optometrist).

In one example, image 406 may pass, traverse, and/or travel through various components of conoscope 102 (including, e.g., frontend lenses 202, circular polarizer 210, and/or backend lenses 204, etc.) along an optical path 416 before reaching image sensor 408 for evaluation and/or analysis. In this example, image 406 may also pass, traverse, and/or travel through a selected feature of variable compensation element 104 before reaching image sensor 408 for evaluation and/or analysis. Upon doing so, image 406 may undergo and/or experience a transformation and/or alteration that returns the collimated light back to its original form (e.g., prior to the optical effects imparted by corrective lens 404). In other words, the selected feature of variable compensation element 104 may condition and/or treat the collimated light such that image 406 arrives at image sensor 408 in the form that preceded corrective lens 404. In certain examples, image sensor 408 may detect, sense, analyze, and/or evaluate image 406 to gain information about and/or insight into the quality of image 406 projected and/or presented by display device 402.

In some examples, conoscope 102 may include and/or represent an optical tray 414 positioned and/or located in and/or along optical path 416 traversed by image 406. In one example, variable compensation element 104 may be inserted and/or installed into optical tray 414. In this example, optical tray 414 may constitute, represent, and/or form an interface and/or socket between variable compensation element 104 and/or conoscope 102. Additionally or alternatively, phase-plate positioning mechanism 304 may engage one or more actuators to move variable compensation element 104 relative to optical tray 414. As a result of such movement, phase-plate positioning mechanism 304 may effectively apply and/or align a selectable feature of variable compensation element 104 to image 406 as image 406 traverses optical path 416 within conoscope 102.

In some examples, image sensor 408 may be communicatively coupled to controller 106 and/or may provide data representative of image 406 to controller 106 for further evaluation and/or analysis. In one example, controller 106 may receive data representative of image 406 from image sensor 408. In this example, controller 106 may determine, extrapolate, and/or identify one or more display parameters of display device 402 based at least in part on the data representative of image 406. Examples of such display parameters include, without limitation, an MTF of display device 402, a color uniformity measurement of display device 402, a resolution (e.g., angular resolution) of display device 402, a sharpness measurement of display device 402, a brightness uniformity measurement of display device 402, combinations or variations of one or more of the same, and/or any other suitable display parameters.

In some examples, controller 106 may use such display parameters to determine whether display device 402 meets and/or satisfies certain quality standards. Additionally or alternatively, controller 106 may provide such display parameters to a computing device and/or user interface (e.g., a monitor) operated and/or accessible to a technician responsible for ensuring certain quality standards for display device 402. In one example, controller 106 may devise a strategy for correcting one or more deficiencies detected in display device 402 based at least in part on the display parameters. Further, controller 106 may initiate and/or perform one or more actions directed to correcting one or more deficiencies detected in display device 402. For example, controller 106 may inform and/or notify the technician of how to correct and/or address one or more deficiencies detected in display device 402.

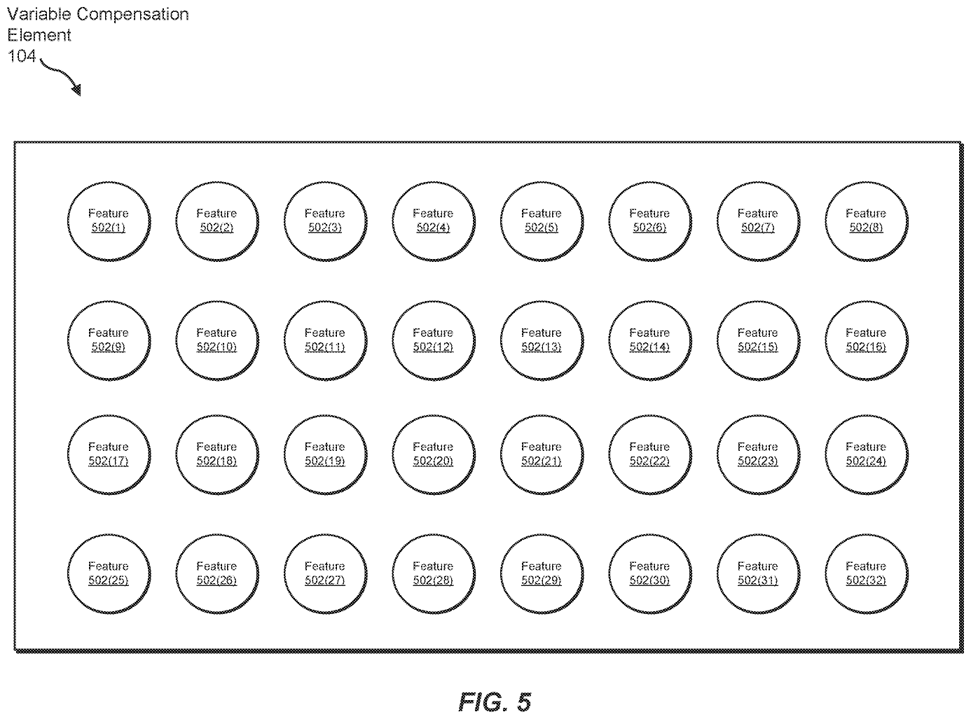

FIG. 5 illustrates an exemplary implementation of variable compensation element 104. In some examples, the exemplary implementation of variable compensation element 104 in FIG. 5 may include and/or represent a phase plate array with a set of PBP optical elements and/or correctors. As illustrated in FIG. 5, this implementation of variable compensation element 104 may include and/or represent features 502(1), 502(2), 502(3), 502(4), 502(5), 502(6), 502(7), 502(8), 502(9), 502(10), 502(11), 502(12), 502(13), 502(14), 502(15), 502(16), 502(17), 502(18), 502(19), 502(20), 502(21), 502(22), 502(23), 502(24), 502(25), 502(26), 502(27), 502(28), 502(29), 502(30), 502(31), and/or 502(32). In one example, each of features 502(1)-(32) may include and/or represent a different and/or unique PBP optical element. In this example, features 502(1)-(32) may include and/or represent combinations of different spherical and/or cylindrical powers.

In some examples, controller 106 may select one of features 502(1)-(32) from variable compensation element 104 for application to image 406. As a specific example, feature 502(1) may include and/or represent a combination of 0 diopters of SPH and 0 diopters of CYL. In this example, feature 502(16) may include and/or represent a combination of −4 diopters of SPH and −0.5 diopters of CYL. Additionally or alternatively, feature 502(32) may include and/or represent a combination of −4 diopters of SPH and −1.5 diopters of CYL.

FIG. 6 is a flow diagram of an exemplary method 500 for manufacturing and/or assembling an imaging camera device that facilitates selectively compensating for corrective lenses applied to display devices during testing. Additionally or alternatively, the steps shown in FIG. 6 may incorporate and/or involve various sub-steps and/or variations consistent with the descriptions provided above in connection with FIGS. 1-5.

As illustrated in FIG. 6, method 600 may include and/or involve the step of optically coupling a display device to a conoscope configured to receive an image emitted by a display device through a corrective lens (610). Step 610 may be performed in a variety of ways, including any of those described above in connection with FIGS. 1-5. For example, a testing equipment manufacturer and/or contractor may optically couple a display device to a conoscope configured to receive an image emitted by a display device through a corrective lens.

Method 600 may also include and/or involve the step of receiving a compensation parameter representative of the optical effect imparted by the corrective lens of the image (620). Step 620 may be performed in a variety of ways, including any of those described above in connection with FIGS. 1-5. For example, a controller may be coupled to a variable compensation element positioned in an optical path of a conoscope. In this example, the controller may receive a compensation parameter representative of the optical effect imparted by the corrective lens of the image.

Method 600 may also include and/or involve the step of selecting a feature of the variable compensation element that compensates for the optical effect based at least in part on the compensation parameter (630). Step 630 may be performed in a variety of ways, including any of those described above in connection with FIGS. 1-5. For example, the controller may select the feature of the variable compensation element that compensates for the optical effect based at least in part on the compensation parameter.

Method 600 may also include and/or involve the step of causing the feature of the variable compensation element to be applied to the image in the conoscope (640). Step 640 may be performed in a variety of ways, including any of those described above in connection with FIGS. 1-5. For example, the controller may cause the feature of the variable compensation element to be applied to the image in the conoscope.

### EXAMPLE EMBODIMENTS

Example 1: An apparatus comprising (1) a conoscope configured to receive an image emitted by a display device through a corrective lens, (2) a variable compensation element coupled to the conoscope, wherein the variable compensation element is capable of selectively modifying the image emitted by the display device to compensate for an optical effect imparted by the corrective lens on the image, and (3) a controller coupled to the variable compensation element, wherein the controller (1) receives a compensation parameter representative of the optical effect imparted by the corrective lens on the image, (2) selects, based at least in part on the compensation parameter, a feature of the variable compensation element that compensates for the optical effect, and (3) causing the feature of the variable compensation element to be applied to the image.

Example 2: The apparatus of Example 1, further comprising an image sensor coupled to the variable compensation element, wherein (1) the image sensor is configured to sense the image after being compensated by the feature of the variable compensation element and (2) the controller (A) receives, from the image sensor, data representative of the image as sensed by the image sensor and (B) determines, based at least in part on the data representative of the image, a display parameter of the display device.

Example 3: The apparatus of Example 1 or 2, wherein the display parameter comprises at least one of (1) a modulation transfer function of the display device, (2) a color uniformity measurement of the display device, (3) a resolution of the display device, (4) a sharpness measurement of the display device, or (5) a brightness uniformity measurement of the display device.

Example 4: The apparatus of any of Examples 1-3, wherein (1) the variable compensation element comprises a phase plate array that includes a plurality of selectable features and (2) the controller selects one of the selectable features included on the phase plate array for application on the image before the image reaches the image sensor.

Example 5: The apparatus of any of Examples 1-4, wherein the selectable features included on the phase plate array comprise at least one of a set of Pancharatnam-Berry phase optical elements.

Example 6: The apparatus of any of Examples 1-5, further comprising a phase-plate positioning mechanism that is communicatively coupled to the controller and configured to move the phase plate array, wherein the controller directs the phase-plate positioning mechanism to move the phase plate array to a position that causes the one of the selectable features to be applied to the image as the image passes through the conoscope.

Example 7: The apparatus of any of Examples 1-6, wherein (1) the phase-plate positioning mechanism comprises one or more actuators, (2) the conoscope comprises an optical tray positioned in an optical path of the image, and (3) the phase-plate positioning mechanism engages the actuators to move the phase plate array relative to the optical tray such that the one of the selectable features is applied to the image as the image traverses the optical path within the conoscope.

Example 8: The apparatus of any of Examples 1-7, wherein the controller provides the display parameter representative of the display device to a user interface or a computing device for evaluation.

Example 9: The apparatus of any of Examples 1-8, wherein the compensation parameter comprises at least one of (1) a spherical power of the corrective lens, (2) a cylindrical power of the corrective lens, or (3) a cylindrical axis of the corrective lens.

Example 10: The apparatus of any of Examples 1-9, wherein the conoscope comprises (1) a light-collection lens configured to collect light representative of the image emitted by the display device and (2) an image-forming lens configured to form the image from the light for presentation on the image sensor.

Example 11: The apparatus of Examples 1-10, wherein the light-collection lens collects the light as emitted by the display device over a range of viewing angles.

Example 12: A system comprising (1) a display device and (2) an imaging camera device optically coupled to the display device, wherein the imaging camera device comprising (A) a conoscope configured to receive an image emitted by a display device through a corrective lens, (B) a variable compensation element coupled to the conoscope, wherein the variable compensation element is capable of selectively modifying the image emitted by the display device to compensate for an optical effect imparted by the corrective lens on the image, and (C) a controller coupled to the variable compensation element, wherein the controller (I) receives a compensation parameter representative of the optical effect imparted by the corrective lens on the image, (II) selects, based at least in part on the compensation parameter, a feature of the variable compensation element that compensates for the optical effect, and (III) causes the feature of the variable compensation element to be applied to the image.

Example 13: The system of Example 12, wherein (1) the imaging camera device comprises an image sensor coupled to the variable compensation element, (2) the image sensor is configured to sense the image after being compensated by the feature of the variable compensation element, and (3) the controller (I) receives, from the image sensor, data representative of the image as sensed by the image sensor and (II) determines, based at least in part on the data representative of the image, a display parameter representative of the display device.

Example 14: The system of Example 12 or 13, wherein the display parameter comprises at least one of (1) a modulation transfer function of the display device, (2) a color uniformity measurement of the display device, (3) a resolution of the display device, (4) a sharpness measurement of the display device, or (5) a brightness uniformity measurement of the display device.

Example 15: The system of any of Examples 12-14, wherein (1) the variable compensation element comprises a phase plate array that includes a plurality of selectable features and (2) the controller selects one of the selectable features included on the phase plate array for application on the image before the image reaches the image sensor.

Example 16: The system of any of Examples 12-15, wherein the selectable features included on the phase plate array comprise at least one of a set of Pancharatnam-Berry phase optical elements.

Example 17: The system of any of Examples 12-16, further comprising a phase-plate positioning mechanism that is communicatively coupled to the controller and configured to move the phase plate array, wherein the controller directs the phase-plate positioning mechanism to move the phase plate array to a position that causes the one of the selectable features to be applied to the image as the image passes through the conoscope.

Example 18: The system of any of Examples 12-17, wherein (1) the phase-plate positioning mechanism comprises one or more actuators, (2) the conoscope comprises an optical tray positioned in an optical path of the image, and (3) the phase-plate positioning mechanism engages the actuators to move the phase plate array relative to the optical tray such that the one of the selectable features is applied to the image as the image traverses the optical path within the conoscope.

Example 19: The system of any of Examples 12-18, wherein the controller provides the display parameter representative of the display device to a user interface or a computing device for evaluation.

Example 20: A method comprising (1) optically coupling a display device to a conoscope configured to receive an image emitted by a display device through a corrective lens, (2) receiving, by a controller coupled to a variable compensation element positioned in an optical path of the conoscope, a compensation parameter representative of the optical effect imparted by the corrective lens on the image, (3) selecting, by the controller, a feature of the variable compensation element that compensates for the optical effect based at least in part on the compensation parameter, and (4) causing, by the controller, the feature of the variable compensation element to be applied to the image in the conoscope.

Embodiments of the present disclosure may include or be implemented in conjunction with various types of artificial-reality systems. Artificial reality is a form of reality that has been adjusted in some manner before presentation to a user, which may include, for example, a virtual reality, an augmented reality, a mixed reality, a hybrid reality, or some combination and/or derivative thereof. Artificial-reality content may include completely computer-generated content or computer-generated content combined with captured (e.g., real-world) content. The artificial-reality content may include video, audio, haptic feedback, or some combination thereof, any of which may be presented in a single channel or in multiple channels (such as stereo video that produces a three-dimensional (3D) effect to the viewer). Additionally, in some embodiments, artificial reality may also be associated with applications, products, accessories, services, or some combination thereof, that are used to, for example, create content in an artificial reality and/or are otherwise used in (e.g., to perform activities in) an artificial reality.

Artificial-reality systems may be implemented in a variety of different form factors and configurations. Some artificial-reality systems may be designed to work without near-eye displays (NEDs). Other artificial-reality systems may include an NED that also provides visibility into the real world (such as, e.g., augmented-reality system 700 in FIG. 7) or that visually immerses a user in an artificial reality (such as, e.g., virtual-reality system 800 in FIG. 8). While some artificial-reality devices may be self-contained systems, other artificial-reality devices may communicate and/or coordinate with external devices to provide an artificial-reality experience to a user. Examples of such external devices include handheld controllers, mobile devices, desktop computers, devices worn by a user, devices worn by one or more other users, and/or any other suitable external system.

Turning to FIG. 7, augmented-reality system 700 may include an eyewear device 702 with a frame 710 configured to hold a left display device 715(A) and a right display device 715(B) in front of a user's eyes. Display devices 715(A) and 715(B) may act together or independently to present an image or series of images to a user. While augmented-reality system 700 includes two displays, embodiments of this disclosure may be implemented in augmented-reality systems with a single NED or more than two NEDs.

In some embodiments, augmented-reality system 700 may include one or more sensors, such as sensor 740. Sensor 740 may generate measurement signals in response to motion of augmented-reality system 700 and may be located on substantially any portion of frame 710. Sensor 740 may represent one or more of a variety of different sensing mechanisms, such as a position sensor, an inertial measurement unit (IMU), a depth camera assembly, a structured light emitter and/or detector, or any combination thereof. In some embodiments, augmented-reality system 700 may or may not include sensor 740 or may include more than one sensor. In embodiments in which sensor 740 includes an IMU, the IMU may generate calibration data based on measurement signals from sensor 740. Examples of sensor 740 may include, without limitation, accelerometers, gyroscopes, magnetometers, other suitable types of sensors that detect motion, sensors used for error correction of the IMU, or some combination thereof.

In some examples, augmented-reality system 700 may also include a microphone array with a plurality of acoustic transducers 720(A)-720(J), referred to collectively as acoustic transducers 720. Acoustic transducers 720 may represent transducers that detect air pressure variations induced by sound waves. Each acoustic transducer 720 may be configured to detect sound and convert the detected sound into an electronic format (e.g., an analog or digital format). The microphone array in FIG. 7 may include, for example, ten acoustic transducers: 720(A) and 720(B), which may be designed to be placed inside a corresponding ear of the user, acoustic transducers 720(C), 720(D), 720(E), 720(F), 720(G), and 720(H), which may be positioned at various locations on frame 710, and/or acoustic transducers 720(1) and 720(J), which may be positioned on a corresponding neckband 705.

In some embodiments, one or more of acoustic transducers 720(A)-(J) may be used as output transducers (e.g., speakers). For example, acoustic transducers 720(A) and/or 720(B) may be earbuds or any other suitable type of headphone or speaker.

The configuration of acoustic transducers 720 of the microphone array may vary. While augmented-reality system 700 is shown in FIG. 7 as having ten acoustic transducers 720, the number of acoustic transducers 720 may be greater or less than ten. In some embodiments, using higher numbers of acoustic transducers 720 may increase the amount of audio information collected and/or the sensitivity and accuracy of the audio information. In contrast, using a lower number of acoustic transducers 720 may decrease the computing power required by an associated controller 750 to process the collected audio information. In addition, the position of each acoustic transducer 720 of the microphone array may vary. For example, the position of an acoustic transducer 720 may include a defined position on the user, a defined coordinate on frame 710, an orientation associated with each acoustic transducer 720, or some combination thereof.

Acoustic transducers 720(A) and 720(B) may be positioned on different parts of the user's ear, such as behind the pinna, behind the tragus, and/or within the auricle or fossa. Or, there may be additional acoustic transducers 720 on or surrounding the ear in addition to acoustic transducers 720 inside the ear canal. Having an acoustic transducer 720 positioned next to an ear canal of a user may enable the microphone array to collect information on how sounds arrive at the ear canal. By positioning at least two of acoustic transducers 720 on either side of a user's head (e.g., as binaural microphones), augmented-reality system 700 may simulate binaural hearing and capture a 3D stereo sound field around about a user's head. In some embodiments, acoustic transducers 720(A) and 720(B) may be connected to augmented-reality system 700 via a wired connection 730, and in other embodiments acoustic transducers 720(A) and 720(B) may be connected to augmented-reality system 700 via a wireless connection (e.g., a BLUETOOTH connection). In still other embodiments, acoustic transducers 720(A) and 720(B) may not be used at all in conjunction with augmented-reality system 700.

Acoustic transducers 720 on frame 710 may be positioned in a variety of different ways, including along the length of the temples, across the bridge, above or below display devices 715(A) and 715(B), or some combination thereof. Acoustic transducers 720 may also be oriented such that the microphone array is able to detect sounds in a wide range of directions surrounding the user wearing the augmented-reality system 700. In some embodiments, an optimization process may be performed during manufacturing of augmented-reality system 700 to determine relative positioning of each acoustic transducer 720 in the microphone array.

In some examples, augmented-reality system 700 may include or be connected to an external device (e.g., a paired device), such as neckband 705. Neckband 705 generally represents any type or form of paired device. Thus, the following discussion of neckband 705 may also apply to various other paired devices, such as charging cases, smart watches, smart phones, wrist bands, other wearable devices, hand-held controllers, tablet computers, laptop computers, other external compute devices, etc.

As shown, neckband 705 may be coupled to eyewear device 702 via one or more connectors. The connectors may be wired or wireless and may include electrical and/or non-electrical (e.g., structural) components. In some cases, eyewear device 702 and neckband 705 may operate independently without any wired or wireless connection between them. While FIG. 7 illustrates the components of eyewear device 702 and neckband 705 in example locations on eyewear device 702 and neckband 705, the components may be located elsewhere and/or distributed differently on eyewear device 702 and/or neckband 705. In some embodiments, the components of eyewear device 702 and neckband 705 may be located on one or more additional peripheral devices paired with eyewear device 702, neckband 705, or some combination thereof.

Pairing external devices, such as neckband 705, with augmented-reality eyewear devices may enable the eyewear devices to achieve the form factor of a pair of glasses while still providing sufficient battery and computation power for expanded capabilities. Some or all of the battery power, computational resources, and/or additional features of augmented-reality system 700 may be provided by a paired device or shared between a paired device and an eyewear device, thus reducing the weight, heat profile, and form factor of the eyewear device overall while still retaining desired functionality. For example, neckband 705 may allow components that would otherwise be included on an eyewear device to be included in neckband 705 since users may tolerate a heavier weight load on their shoulders than they would tolerate on their heads. Neckband 705 may also have a larger surface area over which to diffuse and disperse heat to the ambient environment. Thus, neckband 705 may allow for greater battery and computation capacity than might otherwise have been possible on a stand-alone eyewear device. Since weight carried in neckband 705 may be less invasive to a user than weight carried in eyewear device 702, a user may tolerate wearing a lighter eyewear device and carrying or wearing the paired device for greater lengths of time than a user would tolerate wearing a heavy standalone eyewear device, thereby enabling users to more fully incorporate artificial-reality environments into their day-to-day activities.

Neckband 705 may be communicatively coupled with eyewear device 702 and/or to other devices. These other devices may provide certain functions (e.g., tracking, localizing, depth mapping, processing, storage, etc.) to augmented-reality system 700. In the embodiment of FIG. 7, neckband 705 may include two acoustic transducers (e.g., 720(1) and 720(J)) that are part of the microphone array (or potentially form their own microphone subarray). Neckband 705 may also include a controller 725 and a power source 735.

Acoustic transducers 720(1) and 720(J) of neckband 705 may be configured to detect sound and convert the detected sound into an electronic format (analog or digital). In the embodiment of FIG. 7, acoustic transducers 720(1) and 720(J) may be positioned on neckband 705, thereby increasing the distance between the neckband acoustic transducers 720(1) and 720(J) and other acoustic transducers 720 positioned on eyewear device 702. In some cases, increasing the distance between acoustic transducers 720 of the microphone array may improve the accuracy of beamforming performed via the microphone array. For example, if a sound is detected by acoustic transducers 720(C) and 720(D) and the distance between acoustic transducers 720(C) and 720(D) is greater than, e.g., the distance between acoustic transducers 720(D) and 720(E), the determined source location of the detected sound may be more accurate than if the sound had been detected by acoustic transducers 720(D) and 720(E).

Controller 725 of neckband 705 may process information generated by the sensors on neckband 705 and/or augmented-reality system 700. For example, controller 725 may process information from the microphone array that describes sounds detected by the microphone array. For each detected sound, controller 725 may perform a direction-of-arrival (DOA) estimation to estimate a direction from which the detected sound arrived at the microphone array. As the microphone array detects sounds, controller 725 may populate an audio data set with the information. In embodiments in which augmented-reality system 700 includes an inertial measurement unit, controller 725 may compute all inertial and spatial calculations from the IMU located on eyewear device 702. A connector may convey information between augmented-reality system 700 and neckband 705 and between augmented-reality system 700 and controller 725. The information may be in the form of optical data, electrical data, wireless data, or any other transmittable data form. Moving the processing of information generated by augmented-reality system 700 to neckband 705 may reduce weight and heat in eyewear device 702, making it more comfortable for the user.

Power source 735 in neckband 705 may provide power to eyewear device 702 and/or to neckband 705. Power source 735 may include, without limitation, lithium ion batteries, lithium-polymer batteries, primary lithium batteries, alkaline batteries, or any other form of power storage. In some cases, power source 735 may be a wired power source. Including power source 735 on neckband 705 instead of on eyewear device 702 may help better distribute the weight and heat generated by power source 735.

As noted, some artificial-reality systems may, instead of blending an artificial reality with actual reality, substantially replace one or more of a user's sensory perceptions of the real world with a virtual experience. One example of this type of system is a head-worn display system, such as virtual-reality system 800 in FIG. 8, that mostly or completely covers a user's field of view. Virtual-reality system 800 may include a front rigid body 802 and a band 804 shaped to fit around a user's head. Virtual-reality system 800 may also include output audio transducers 806(A) and 806(B). Furthermore, while not shown in FIG. 8, front rigid body 802 may include one or more electronic elements, including one or more electronic displays, one or more inertial measurement units (IMUS), one or more tracking emitters or detectors, and/or any other suitable device or system for creating an artificial-reality experience.

Artificial-reality systems may include a variety of types of visual feedback mechanisms. For example, display devices in augmented-reality system 700 and/or virtual-reality system 800 may include one or more liquid crystal displays (LCDs), light emitting diode (LED) displays, microLED displays, organic LED (OLED) displays, digital light project (DLP) micro-displays, liquid crystal on silicon (LCoS) micro-displays, and/or any other suitable type of display screen. These artificial-reality systems may include a single display screen for both eyes or may provide a display screen for each eye, which may allow for additional flexibility for varifocal adjustments or for correcting a user's refractive error. Some of these artificial-reality systems may also include optical subsystems having one or more lenses (e.g., concave or convex lenses, Fresnel lenses, adjustable liquid lenses, etc.) through which a user may view a display screen. These optical subsystems may serve a variety of purposes, including to collimate (e.g., make an object appear at a greater distance than its physical distance), to magnify (e.g., make an object appear larger than its actual size), and/or to relay (to, e.g., the viewer's eyes) light. These optical subsystems may be used in a non-pupil-forming architecture (such as a single lens configuration that directly collimates light but results in so-called pincushion distortion) and/or a pupil-forming architecture (such as a multi-lens configuration that produces so-called barrel distortion to nullify pincushion distortion).

In addition to or instead of using display screens, some of the artificial-reality systems described herein may include one or more projection systems. For example, display devices in augmented-reality system 700 and/or virtual-reality system 800 may include micro-LED projectors that project light (using, e.g., a waveguide) into display devices, such as clear combiner lenses that allow ambient light to pass through. The display devices may refract the projected light toward a user's pupil and may enable a user to simultaneously view both artificial-reality content and the real world. The display devices may accomplish this using any of a variety of different optical components, including waveguide components (e.g., holographic, planar, diffractive, polarized, and/or reflective waveguide elements), light-manipulation surfaces and elements (such as diffractive, reflective, and refractive elements and gratings), coupling elements, etc. Artificial-reality systems may also be configured with any other suitable type or form of image projection system, such as retinal projectors used in virtual retina displays.

The artificial-reality systems described herein may also include various types of computer vision components and subsystems. For example, augmented-reality system 700 and/or virtual-reality system 800 may include one or more optical sensors, such as two-dimensional (2D) or 3D cameras, structured light transmitters and detectors, time-of-flight depth sensors, single-beam or sweeping laser rangefinders, 3D LiDAR sensors, and/or any other suitable type or form of optical sensor. An artificial-reality system may process data from one or more of these sensors to identify a location of a user, to map the real world, to provide a user with context about real-world surroundings, and/or to perform a variety of other functions.

The artificial-reality systems described herein may also include one or more input and/or output audio transducers. Output audio transducers may include voice coil speakers, ribbon speakers, electrostatic speakers, piezoelectric speakers, bone conduction transducers, cartilage conduction transducers, tragus-vibration transducers, and/or any other suitable type or form of audio transducer. Similarly, input audio transducers may include condenser microphones, dynamic microphones, ribbon microphones, and/or any other type or form of input transducer. In some embodiments, a single transducer may be used for both audio input and audio output.

In some embodiments, the artificial-reality systems described herein may also include tactile (i.e., haptic) feedback systems, which may be incorporated into headwear, gloves, bodysuits, handheld controllers, environmental devices (e.g., chairs, floor mats, etc.), and/or any other type of device or system. Haptic feedback systems may provide various types of cutaneous feedback, including vibration, force, traction, texture, and/or temperature. Haptic feedback systems may also provide various types of kinesthetic feedback, such as motion and compliance. Haptic feedback may be implemented using motors, piezoelectric actuators, fluidic systems, and/or a variety of other types of feedback mechanisms. Haptic feedback systems may be implemented independent of other artificial-reality devices, within other artificial-reality devices, and/or in conjunction with other artificial-reality devices.

By providing haptic sensations, audible content, and/or visual content, artificial-reality systems may create an entire virtual experience or enhance a user's real-world experience in a variety of contexts and environments. For instance, artificial-reality systems may assist or extend a user's perception, memory, or cognition within a particular environment. Some systems may enhance a user's interactions with other people in the real world or may enable more immersive interactions with other people in a virtual world. Artificial-reality systems may also be used for educational purposes (e.g., for teaching or training in schools, hospitals, government organizations, military organizations, business enterprises, etc.), entertainment purposes (e.g., for playing video games, listening to music, watching video content, etc.), and/or for accessibility purposes (e.g., as hearing aids, visual aids, etc.). The embodiments disclosed herein may enable or enhance a user's artificial-reality experience in one or more of these contexts and environments and/or in other contexts and environments.

The process parameters and sequence of the steps described and/or illustrated herein are given by way of example only and can be varied as desired. For example, while the steps illustrated and/or described herein may be shown or discussed in a particular order, these steps do not necessarily need to be performed in the order illustrated or discussed. The various exemplary methods described and/or illustrated herein may also omit one or more of the steps described or illustrated herein or include additional steps in addition to those disclosed.

The preceding description has been provided to enable others skilled in the art to best utilize various aspects of the exemplary embodiments disclosed herein. This exemplary description is not intended to be exhaustive or to be limited to any precise form disclosed. Many modifications and variations are possible without departing from the spirit and scope of the present disclosure. The embodiments disclosed herein should be considered in all respects illustrative and not restrictive. Reference should be made to any claims appended hereto and their equivalents in determining the scope of the present disclosure.

Unless otherwise noted, the terms “connected to” and “coupled to” (and their derivatives), as used in the specification and/or claims, are to be construed as permitting both direct and indirect (i.e., via other elements or components) connection. In addition, the terms “a” or “an,” as used in the specification and/or claims, are to be construed as meaning “at least one of.” Finally, for ease of use, the terms “including” and “having” (and their derivatives), as used in the specification and/or claims, are interchangeable with and have the same meaning as the word “comprising.”

What is claimed is:

1. An apparatus comprising:
a conoscope configured to receive an image emitted by a display device through a corrective lens;
a variable compensation element coupled to the conoscope, wherein the variable compensation element is capable of selectively modifying the image emitted by the display device to compensate for an optical effect imparted by the corrective lens on the image; and
a controller coupled to the variable compensation element, wherein the controller:
receives a compensation parameter representative of the optical effect imparted by the corrective lens on the image;
selects, based at least in part on the compensation parameter, a feature of the variable compensation element that compensates for the optical effect; and
causing the feature of the variable compensation element to be applied to the image.

2. The apparatus of claim 1, further comprising an image sensor coupled to the variable compensation element, wherein:
the image sensor is configured to sense the image after being compensated by the feature of the variable compensation element; and
the controller:
receives, from the image sensor, data representative of the image as sensed by the image sensor; and
determines, based at least in part on the data representative of the image, a display parameter of the display device.

3. The apparatus of claim 2, wherein the display parameter comprises at least one of:
a modulation transfer function of the display device;
a color uniformity measurement of the display device;
a resolution of the display device;
a sharpness measurement of the display device; or
a brightness uniformity measurement of the display device.

4. The apparatus of claim 2, wherein:
the variable compensation element comprises a phase plate array that includes a plurality of selectable features; and
the controller selects one of the selectable features included on the phase plate array for application on the image before the image reaches the image sensor.

5. The apparatus of claim 4, wherein the selectable features included on the phase plate array comprise at least one of a set of Pancharatnam-Berry phase optical elements.

6. The apparatus of claim 4, further comprising a phase-plate positioning mechanism that is communicatively coupled to the controller and configured to move the phase plate array; and
wherein the controller directs the phase-plate positioning mechanism to move the phase plate array to a position that causes the one of the selectable features to be applied to the image as the image passes through the conoscope.

7. The apparatus of claim 6, wherein:
the phase-plate positioning mechanism comprises one or more actuators;
the conoscope comprises an optical tray positioned in an optical path of the image; and
the phase-plate positioning mechanism engages the actuators to move the phase plate array relative to the optical tray such that the one of the selectable features is applied to the image as the image traverses the optical path within the conoscope.

8. The apparatus of claim 2, wherein the controller provides the display parameter representative of the display device to a user interface or a computing device for evaluation.

9. The apparatus of claim 1, wherein the compensation parameter comprises at least one of:
a spherical power of the corrective lens;
a cylindrical power of the corrective lens; or
a cylindrical axis of the corrective lens.

10. The apparatus of claim 1, wherein the conoscope comprises:
a light-collection lens configured to collect light representative of the image emitted by the display device; and
an image-forming lens configured to form the image from the light for presentation on the image sensor.

11. The apparatus of claim 1, wherein the light-collection lens collects the light as emitted by the display device over a range of viewing angles.

12. A system comprising:
a display device that includes a corrective lens; and
an imaging camera device optically coupled to the display device, wherein the imaging camera device comprising:
a conoscope configured to receive an image emitted by the display device through the corrective lens;
a variable compensation element coupled to the conoscope, wherein the variable compensation element is capable of selectively modifying the image emitted by the display device to compensate for an optical effect imparted by the corrective lens on the image; and
a controller coupled to the variable compensation element, wherein the controller:
receives a compensation parameter representative of the optical effect imparted by the corrective lens on the image;
selects, based at least in part on the compensation parameter, a feature of the variable compensation element that compensates for the optical effect; and
causes the feature of the variable compensation element to be applied to the image.

13. The system of claim 12, wherein:
the imaging camera device comprises an image sensor coupled to the variable compensation element;
the image sensor is configured to sense the image after being compensated by the feature of the variable compensation element; and
the controller:
receives, from the image sensor, data representative of the image as sensed by the image sensor; and
determines, based at least in part on the data representative of the image, a display parameter of the display device.

14. The system of claim 13, wherein the display parameter comprises at least one of:
a modulation transfer function of the display device;
a color uniformity measurement of the display device;
a resolution of the display device;
a sharpness measurement of the display device; or
a brightness uniformity measurement of the display device.

15. The system of claim 13, wherein:
the variable compensation element comprises a phase plate array that includes a plurality of selectable features; and
the controller selects one of the selectable features included on the phase plate array for application on the image before the image reaches the image sensor.

16. The system of claim 15, wherein the selectable features included on the phase plate array comprise at least one of a set of Pancharatnam-Berry phase optical elements.

17. The system of claim 15, further comprising a phase-plate positioning mechanism that is communicatively coupled to the controller and configured to move the phase plate array; and
wherein the controller directs the phase-plate positioning mechanism to move the phase plate array to a position that causes the one of the selectable features to be applied to the image as the image passes through the conoscope.

18. The system of claim 17, wherein:
the phase-plate positioning mechanism comprises one or more actuators;
the conoscope comprises an optical tray positioned in an optical path of the image; and
the phase-plate positioning mechanism engages the actuators to move the phase plate array relative to the optical tray such that the one of the selectable features is applied to the image as the image traverses the optical path within the conoscope.

19. The system of claim 12, wherein the controller provides the display parameter representative of the display device to a user interface or a computing device for evaluation.

20. A method comprising:
optically coupling a display device to a conoscope configured to receive an image emitted by the display device through a corrective lens;
receiving, by a controller coupled to a variable compensation element positioned in an optical path of the conoscope, a compensation parameter representative of at least one optical effect imparted by the corrective lens on the image;
selecting, by the controller, a feature of the variable compensation element that compensates for the optical effect based at least in part on the compensation parameter; and
causing, by the controller, the feature of the variable compensation element to be applied to the image in the conoscope.
